(19) United States
(12) Patent Application Publication
(10) Pub. No.: US 2003/0225791 A1
(43) Pub. Date: Dec. 4, 2003

(54) Method and device for fragmenting multimedia data

(76) Inventors: Jurgen Stauder, Montreuil sur Ille (FR); Philippe Robert, Thorigne Fouillard (FR)

Correspondence Address: JOSEPH S. TRIPOLI, THOMSON LICENSING INC., 2 INDEPENDENCE WAY, P. O. BOX 5312, PRINCETON, NJ, 08543-5312, US

(21) Appl. No.: 10/448,235

(22) Filed: May 29, 2003

(30) Foreign Application Priority Data
May 30, 2002 (FR) 0206878

(51) Int. Cl. G06F 7/00

(52) U.S. Cl. 707/104.1

(57) ABSTRACT

The invention relates to a method of fragmenting multimedia data (D′_{5,} D′_{6,} D′_{7,} . . . D′_{11,}) associated with navigation nodes (N′₅, N′₆, N′₇, . . . , N′₁₁), a node (N′ᵢ) controlling access to an associated data item (D′ᵢ) and to a next node (N′ᵢ₊₁).

In accordance with the invention, the invention is characterized in that,

nodes (N′₆, N′₇, N′₈, and N′₉) and data (D′_{6,} D′_{7,} D′₈, and D′₉) associated with the latter in a successive manner are grouped into a temporary cell (C′ₜ), comprising a starting node (N′₅) and the data (D′₅) associated with this node, each node grouped into the temporary cell following a node already included in this temporary cell until the size of the temporary cell reaches a threshold value, then

a pair of nodes (N′₇; N′₈) which follow one another, of the temporary cell (C′ₜ), minimizing a parameter (Tᵢ) dependent on the number of data common to the data (D′₇; D′₈) associated with the two nodes (N′₇; N′₈) of the pair is identified, a definitive cell (C′₅, C′₆, C′₇) being formed with the data (D′₅, D′₆, D′₇) grouped into the temporary cell prior to the data (D′₇) associated with the first node (N′₇) of the pair.

The present invention pertains to a method and to a device for fragmenting multimedia data, in particular data associated with navigation nodes.

### BACKGROUND OF THE INVENTION

The throughput of data transmitted via telecommunication networks, such as the Internet network, and the diversity of these data are constantly increasing, a growing number of terminals and of servers using these networks to transmit or receive data of diverse natures, for example, relating to audio and/or video documents, to programs, to texts, to graphical data coding two- or three-dimensional images, or else to texts with hyperlinks allowing access to new data.

When documents comprise data of various natures, these documents and these data are referred to hereinbelow as multimedia.

The operations performed with data D₀, D₁, D₂, D₃ and D₄ (FIG. 1) such as their coding/decoding, their transmission, their reception and/or their display are simpler and faster to carry out when these data are grouped or fragmented into cells C₀, C₁, C_{2/3} and C₄.

Such a fragmentation makes it possible, for example, to perform the multiplexing of these data during their transmission, or to carry out their processing in tandem with their reception.

Stated otherwise, a fragmentation of the data into cells optimizes the use of the limited, in terms of memory capacity and computational capacity, of the various terminals and servers processing these data, as well as the use of the limited, for example in terms of bandwidth, transmission resources of the networks.

Moreover, it is known to associate navigation nodes N₀, N₁, N₂, N₃ and N₄ with data D₀, D₁, D₂, D₃ and D₄ so as to determine the order of access to the latter. For this purpose, each node Nᵢ comprises means for identifying data Dᵢ which are associated therewith, as well as means for identifying at least one next node N₍ᵢ₊₁₎. Stated otherwise, access to a node N₍ᵢ₊₁₎ and to the data D₍ᵢ₊₁₎ associated therewith is carried out commencing with a previous node Nᵢ.

As represented in FIG. 1, each cell Cᵢ can include the node(s) Nᵢ associated with the data Dᵢ included in this cell Cᵢ.

A navigation graph can be composed of successive nodes such that a node Nᵢ is connected to a single previous node Nᵢ₋₁ and to a single next node Nᵢ₊₁. In this case, such a graph is said to be linear or one-dimensional.

Conversely, a graph can comprise nodes, such as the nodes N₁ or N₄, connected to several nodes. The navigation graph is then said to be nonlinear or multidimensional. In this case, two nodes N₂ and N₄ may be next nodes of one and the same node N₁ (respectively two nodes N₁ and N₃ may be previous nodes of one and the same node N₄). Moreover, the node N₁ being the next to node N₀, the nodes N₂, N₄ and N₀ are referred to hereinbelow as neighbouring nodes of N₀.

When distinct cells Cᵢ and Cₖ comprise identical or redundant data Dᵢ and Dₖ, these cells Cᵢ and Cₖ are said to be redundant. Redundant data such as these are frequently used in multimedia documents where identical data are used for various applications. For example, in an electronic book, one and the same image may be used for the display of various different pages, in which case the data relating to the image are present in each of the cells relating to these pages.

In another example relating to graphical data, data coding an object may be present in cells specific to distinct viewpoints of a scene comprising this object.

However, it is advisable to limit the generation of redundant cells during the fragmentation of data so as to allow faster and simpler processing of the data since the processing of redundant cells causes the repeated processing of identical data. For example, the transmitting of redundant cells requires the repeated transmitting of redundant data.

Stated otherwise, to optimize the fragmentation of multimedia data, it is advisable to group the identical or redundant data into one and the same cell.

To fragment a set of data into cells, it is known to form data cells by considering the quantity of data included in a cell as fragmentation parameter. Stated otherwise, a data cell is generated by grouping neighbouring data into a cell until the latter reaches a given size. Such a method has the drawback of not optimizing the fragmentation of the data in such a way as to avoid the formation of redundant cells.

It is also known to use navigation nodes associated with these data and to consider the nature and/or the application of these data. For this purpose, each node Nᵢ comprises means determining the nature and/or the application of the data associated therewith in such a way as to allow their fragmentation by grouping the data relating to one and the same nature or to one and the same application. Thus, when a document comprises several pages of text, the text data Dᵢ relating to these pages may be fragmented in such a way that the data Dᵢ of a cell Cₖ are specific to a page k of the document.

Thereupon, the transmission of a cell Cₖ will comprise the data Dₖ relating to the page k of the document. In this case, for example, the reception of the first data cells C₁, C₂ . . . and Cₖ allows a user to process pages 1, 2, . . . k while the succeeding pages are being transmitted.

According to another example, data coding images in three dimensions are generally fragmented as a function of the viewpoints relating to a scene and/or to an object. For example, a cell Cₖ may constitute a representation of a scene according to a first viewpoint, while a next cell Cₖ₊₁, that is to say one which is accessible from the cell Cₖ, may comprise data relating to a second viewpoint close to the first so that the switch from the first cell Cₖ to the second cell Cₖ₊₁ corresponds to a displacement of the viewpoint.

According to another example, when the data code a residence comprising several rooms, the data Dᵢ of a cell Cₖ may relate to a room of this residence, while the data Dₙ of a next cell Cₖ₊₁ may relate to a neighbouring room. In this case, the switch from a cell Cₖ to a next cell Cₖ₊₁ will be representative of the switch from one room to a neighbouring room.

However, these fragmentation methods take into account the nature and/or the application of the fragmented data and they therefore cannot be used to fragment multimedia data, of various natures, for which diverse applications, such as graphics and audio, are required simultaneously.

To perform the fragmentation of data relating to images in three dimensions, known fragmentation algorithms use representation criteria such that each node comprises indications relating to a viewpoint of a scene and/or of an object which are coded by the data associated therewith. For example, known object search algorithms described by TELLER and SEQUIN in the article entitled “Visibility preprocessing for interactive walkthroughs” published in the journal SIGG-GRAPH, 91 which may be implemented to identify an object, coded in an image, and allocate a specific cell to the data relating to this object.

However, the method described in this document is peculiar to architectural environments, such as that of a building, the cells Cₖ being predefined so as to comprise graphic images of like nature which relate to an image limited by vertical partitions such as walls. It does not therefore make it possible to fragment graphical data relating to a sector other than architecture. In a manner similar to the methods described above, it does not therefore make it possible to fragment multimedia data.

Patent DE19723102 from MEDIA DESIGN GES MULTIMEDIA & ONLINE PUB published on Nov. 12, 1998 entitled “Verfahren zum Darstellen von und navigieren in umfangreichen, Grafikelemente enthaltenden Dateien” discloses a method of fragmenting data which allocates cartographic data relating to a two-dimensional geographical location map to each cell Cₖ. This method of fragmentation has, in a manner similar to the methods described above, the drawback of depending on the nature of the fragmented data, namely of the two-dimensional cartographic data. Moreover, this method does not handle the case of redundant data which it is advisable to group into one and the same cell as described above.

Similarly, International Patent Application No. WO 0016307 of MICROSOFT entitled “Method and apparatus for visualising and exploring large hierarchical structures” discloses a method making it possible to allocate a navigation graph to data with a view to their fragmentation. However, such fragmentation can be applied only to data between which a prior hierarchy is established. Moreover, it does not make it possible to optimize the fragmentation of data as a function of their redundancy.

In a last example, U.S. Pat. No. 6,014,671 (IBM) published on Jan. 11, 2000 entitled “Interactive retrieval and catching of multidimensional data using view elements” discloses a method making it possible to fragment a picture, in particular one taken from a satellite, and to generate a navigation graph according to spatial or temporal criteria. In a manner similar to the patent described above, this patent describes a fragmentation method relating to data of like natures which does not consider the case of redundant multimedia data.

### BRIEF SUMMARY OF THE INVENTION

The present invention remedies these drawbacks by making it possible to fragment multimedia data, that is to say redundant data of diverse natures, independently of their function and/or of their nature by means of their navigation graph.

More precisely, the invention relates to a method of fragmenting multimedia data associated with navigation nodes, a node controlling access to an associated data item and to at least one next node,

characterized in that,

nodes and data associated with the latter in a successive manner are grouped into a temporary cell, comprising a starting node and the data associated with this node, each node grouped into the temporary cell following a node already included in this temporary cell until the size of the temporary cell reaches a threshold value, then

a pair of nodes which follow one another, of the temporary cell, minimizing a parameter dependent on the number of data common to the data associated with the two nodes of the pair is identified, a definitive cell being formed with the data grouped into the temporary cell prior to the data associated with the first node of the pair.

By virtue of such a method, multimedia data may be fragmented independently of their nature and of their application, this fragmentation being based on the use of the navigation nodes associated with the data.

Moreover, as a function of a criterion limiting the size of the temporary cell, it may be possible to determine a threshold in such a way as to generate cells whose size is adapted to a use such as the multiplexed transmission of data.

Furthermore, the use of a fragmentation parameter proportional to the number of data common to the data associated with the two nodes of the pair tends to form substantially independent cells, that is to say ones which can be processed separately, for example in tandem with their reception by a terminal.

Finally, the method in accordance with the invention generates cells which are optimized in relation to redundant data since redundant data will generally be included in one and the same cell, thus facilitating their processing as described above. Stated otherwise, the number of redundant cells generated by the method in accordance with the invention is generally less than the number of redundant cells generated by a known method of fragmentation.

In one embodiment, the parameter minimized by a pair of nodes in proportion to the number of data common to the data associated with the two nodes of the identified pair is determined.

In one embodiment, the threshold size of the temporary cell is determined as a function of the quantity of data grouped into this cell or as a function of the number of nodes grouped into this cell.

In one embodiment, use is made of the second node of the pair identified as starting node or another as yet ungrouped node to perform a fragmentation of data following this second node by repeating the operations performed during the first fragmentation.

In one embodiment, the parameter is determined in a manner inversely proportional to the quantity of data associated with one of the nodes of the identified pair.

In one embodiment, the parameter is determined in proportion to the ratio between the number of nodes grouped into the temporary cell prior to the first node of the identified pair of nodes and the number of nodes in the temporary cell.

In one embodiment, the multimedia data comprise data relating to at least one of the following documents: an audio document, a video document, a program, a text document.

In this case, according to one embodiment, the video data correspond to at least one of the following elements: an image, a sequence of images, this or these images being two- or three-dimensional, a panorama, graphical data.

According to one embodiment, the images relating to viewpoints of scenes or of objects, neighbouring nodes correspond to viewpoints close to these scenes or to these objects.

The invention also relates to a method of fragmenting multimedia data which are not associated with a navigation graph. Such a method is characterized in that navigation nodes are associated with these data as a function of their nature and/or their function, a compression of these data is performed by eliminating the redundant data, the data retained being associated with the node relating to the data eliminated, and these data are fragmented according to a method of fragmentation in accordance with one of the embodiments of the fragmentation method described above.

In one embodiment, the data considered comprising video data relating to real images and to synthetic images, the navigation nodes are associated with the multimedia data by imposing access to the data relating to real images.

The invention also relates to a computer program product comprising program code instructions for executing the steps of the method of fragmenting multimedia data according to one of the embodiments of a fragmentation method as defined above, when the program is executed on a computer.

The invention also pertains to a device for fragmenting multimedia data associated with navigation nodes comprising:

means for accessing a data item by means of a node associated with this data item,

means for determining access to a second node, the so-called next node, from a first node, the so-called previous node,

characterized in that it comprises:

means for grouping, commencing with a predetermined starting node, into a temporary cell, data whose associated nodes follow one another until this cell reaches a threshold size,

means for identifying a pair of next nodes minimizing a parameter proportional to the number of data common to the data associated with the two nodes of the pair and

means for forming a cell with the data associated with the first node of the pair and with the nodes previous to the latter node,

the said device preferably being adapted to implement a method according to the invention.

In one embodiment, the device comprises means for determining the parameter in proportion to the number of data common to the data associated with the two nodes of the identified pair.

According to one embodiment, the device comprises means for determining the threshold size of the temporary cell as a function of the quantity of data grouped into this cell or as a function of the number of nodes grouped into this cell.

According to one embodiment, the device comprises means for using the second node of the pair identified as starting node for performing a fragmentation of data following this second node by repeating the operations performed during the first fragmentation.

In one embodiment, the device comprises means for determining the parameter in a manner inversely proportional to the quantity of data associated with one of the nodes of the identified pair.

According to one embodiment, the device comprises means for determining the parameter in proportion to the ratio between the number of nodes grouped into the temporary cell prior to the first node of the identified pair of nodes and the number of nodes in the temporary cell.

In one embodiment, the device comprises means for processing multimedia data relating to at least one of the following documents: an audio document, a video document, a program.

In this case, according to one embodiment, the device comprises means for processing video data corresponding to at least one of the following elements: an image, a sequence of images, this or these images being two- or three-dimensional.

According to one embodiment, the images relating to viewpoints of scenes or of objects, the device comprises means for processing nodes such that neighbouring nodes correspond to viewpoints close to these scenes or to these objects.

In one embodiment, the device for fragmenting multimedia data comprises means for associating navigation nodes with these data as a function of their nature and/or their function, for performing a compression of these data by eliminating the redundant data, the data retained being associated with the node relating to the data eliminated, and for fragmenting these data according to a method of fragmentation in accordance with one of the embodiments described above.

In this case, according to one embodiment, the data considered comprising video data relating to real images and to synthetic images, the device comprises means for associating the navigation nodes with the multimedia data so as to impose access to the data relating to real images.

### BRIEF DESCRIPTION OF THE DRAWINGS

Other characteristics and advantages of the invention will become apparent with the description, given hereinbelow without limitation, of certain of its modes of embodiment, while referring to the appended drawings, in which:

FIG. 1, already described, represents cells comprising nodes associated with multimedia data in a known manner, and

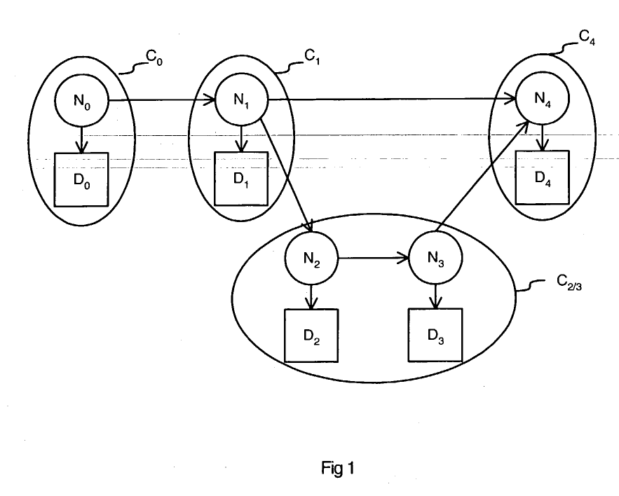

FIG. 2 represents cells comprising nodes associated with multimedia data fragmented in accordance with the invention.

### DETAILED DESCRIPTION OF THE INVENTION

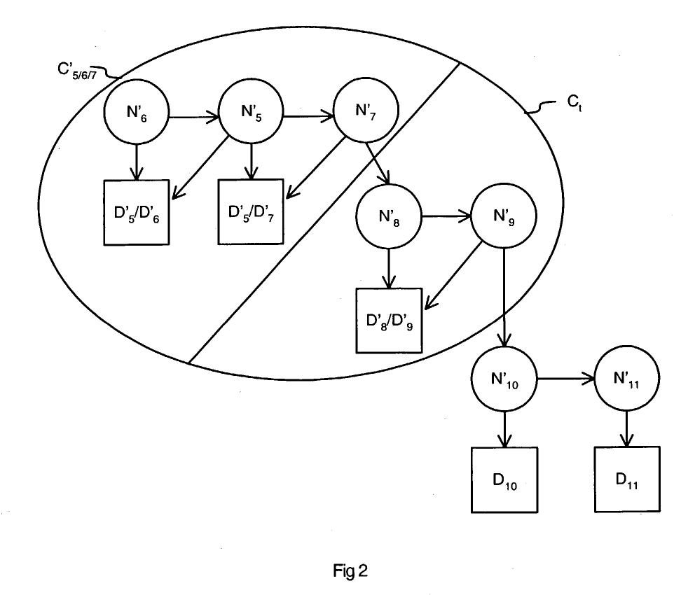

It is recalled that the invention makes it possible to fragment multimedia data D₅′, D₆′, D₇′ D₈′, D₉′, D′₁₀ and D′₁₁ (FIG. 2) associated with a navigation graph comprising nodes N₅′, N₆′, N₇′ N₈′, N₉′, N′₁₀ and N′₁₁, each node Nᵢ′ determining access to the data Dᵢ′ associated therewith as described above.

However, it is possible that the multimedia data Dᵢ′ to be fragmented are not associated, initially, with a navigation graph. In this case, it is necessary to generate this graph before fragmenting the multimedia data.

Such generation can be performed, for example, as a function of the document comprising the data Dᵢ′. Thus, considering a multimedia document formed of pages comprising hypertext links and images, the navigation graph may be generated by allocating cells to each page of this document while the nodes of each cell correspond to the various data of each page.

If the multimedia data relate to images of scenes or of objects, the navigation graph may be composed of nodes relating to the various possible viewpoints of one and the same scene or of one and the same object represented.

In this case, it should be noted that numerous applications, such as video games, use multimedia data relating to real images in order to represent scenes. Therefore, it may be advantageous to generate the navigation graph in such a way as to limit access to these real data whose processing is simpler and faster than the processing of data relating to synthetic images.

In another example, if the data relate to a computer-aided design tool and comprise a hierarchization of the data as a function of the various elements or items used for the design, the navigation graph may be composed of nodes representative of this hierarchy.

In a general manner, if the data are organized according to a preexisting structure, such as a grid or a file structure, a navigation graph may be obtained from this original structure.

When the multimedia data are associated with a navigation graph, a compression of these data is performed by means of this navigation graph. To do this, redundant data Dᵢ′ and Dₙ′ are identified and processed by eliminating data, for example Dₙ′, and by associating the nodes Nᵢ′ and Nₙ′ with the remaining data Dᵢ′, referred to hereinbelow as Dᵢ′/Dₙ′. In FIG. 2, the nodes N₉′ and N₈′ are thus associated with data D₈′/D₉′. Likewise, the nodes N₅′ and N₆′ (respectively the nodes N₆′ and N₇′) are associated with data D₅′/D₆′ (respectively D₆′/D₇′).

Other forms of compression are possible. Thus, in the case of data relating to visual representations associated with a navigation graph, French Patent No. 9911671 entitled “Procédé de construction d'un modéle de scéne 3D par analyse de séquence d'images” [Method of constructing a 3D scene model by analysing image sequences] dated Sep. 17, 1999 filed in the name of Thomson Multimedia, discloses a method for performing a compression of data relating to images in three dimensions and associated with a navigation graph.

For video databases containing descriptions based on three-dimensional images and with which a navigation graph is associated, the Patent FR9911671 already cited describes procedures for adding information relating to visibility to a navigation node so as to determine what information is necessary for the reconstruction of a viewpoint and needs to be associated with this node.

After this compression step, the multimedia data D₅′, D₆′, D₇′ D₈′, D₉′, D′₁₀ and D′₁₁ are fragmented into various data cells C′ᵢ. In accordance with the invention, this fragmentation is performed by performing the following operations:

Firstly, a starting node N₅′ is determined such that from this node N₅′ the entire set of data D′₅, D′₆, D′₇, D′₈, D′_{g}, D′₁₀ and D′₁₁ to be fragmented is accessed, via this starting node, and nodes N′₆, N′₇, N′₈, N′₉, N′₁₀ and N′₁₁ following the latter are accessed.

It should be stressed that, as represented in FIG. 2, the method of fragmentation in accordance with the invention is applied to data associated with a nonlinear navigation graph, the node N′₅ being associated with two nodes N′₆ and N′₇.

Thereafter, data D′₅, D′₆, D′₇, D′₈, D′₉ selected successively are grouped into a temporary cell Cₜ by considering, commencing with the starting node N′₅, the data associated with a node neighbouring the starting node N′₅ or a node whose associated data have been grouped into the temporary cell. For example, the data D′₆ whose node N′₆ neighbours the node N′₅ are grouped into the temporary cell Cₜ. Thereafter, the data D′₇ whose node N′₇ also neighbours the node N′₅ are grouped.

Likewise, the data D′₈ and D′₉ are grouped successively into the temporary cell Cₜ by considering the nodes N′₈ and N′₉ associated with them to be neighbours of a node included in the temporary cell Cₜ. In this example, the nodes associated with the data are also grouped into the temporary cell.

Such a grouping is performed until the number D′₅, D′₆, D′₇, D′₈, D′₉ of data included in the temporary cell reaches a threshold value. In a variant, a limit size of the temporary cell is determined as a function of the number of nodes included in this temporary cell.

When the temporary cell has reached the threshold size, a pair of successive nodes (N′₇; N′₈), that is to say of which a first node N′₇ precedes a second, next, node N′₈, which minimizes a parameter Tᵢ proportional to the number of data D_{c}′ common to the data (D′₇; D′₈) associated with the two nodes (N′₇; N′₈) of the identified pair, is identified. In this example, this parameter Tᵢ takes the following form:

T=((T−(i−5))/T)*rᵢ

Where T is the total number of nodes included in the temporary cell C′ₜ, i−5 is the number of node(s) grouped into the temporary cell prior to the first node N₇′ of the relevant pair of nodes and rᵢ is equal to the ratio between D_{c}′, the number of data common to D′₇ and D′₈, and D′ₘₐₓ, the number of data associated with one of the nodes N′₇ and N′₈ of the pair.

Finally, a definitive cell C′_{5/6/7} is formed comprising the data (D′₅, D′₆, D′₇) grouped successively into the temporary cell until the data associated with the first node N′₇ of the pair.

Subsequently, new definitive cells are formed by repeating the operations described above for which the second node (N′₈) of the identified pair is used as starting node.

In a variant of the invention, a node other than this node (N′₈) of the identified pair is used as starting node.

It is apparent that the method in accordance with the invention tends to limit the formation of redundant cells, since the limit of the definitive cells is obtained with the aid of a pair of nodes (N′₇; N′₈) which minimizes a parameter Tᵢ proportional to the number of data common to two neighbouring nodes, that is to say a pair for which there is no or hardly any redundancy of data between cells.

Stated otherwise, the method in accordance with the invention tends to group the redundant data into definitive cells C′_{5/6/7}, thereby facilitating their processing as described above.

Subsequently, the fragmentation of the data associated with the second node N₈ of the pair (N₇′; N₈′) identified and with the nodes (N₉′, N₁₀′, . . . N_{z}′) following the latter node is performed by repeating the operations described above while taking the second node (N′₈) of the identified pair as starting node in order to form a new temporary cell.

As described above, in a variant of the invention, a node other than the second node of the identified pair is used as starting node for a new fragmentation.

1. Method of fragmenting multimedia data associated with navigation nodes, a node controlling access to an associated data item and to at least one next node,
wherein,
nodes and data associated with the latter in a successive manner are grouped into a temporary cell, comprising a starting node and the data associated with this node, each node grouped into the temporary cell following a node already included in this temporary cell until the size of the temporary cell reaches a threshold value, then
a pair of nodes which follow one another, of the temporary cell, minimizing a parameter dependent on the number of data common to the data associated with the two nodes of the pair is identified, a definitive cell being formed with the data grouped into the temporary cell prior to the data associated with the first node of the pair.

2. Method according to claim 1, wherein the parameter minimized by a pair of nodes in proportion to the number of data common to the data associated with the two nodes of the identified pair is determined.

3. Method according to claim 1, wherein the threshold size of the temporary cell is determined as a function of the quantity of data grouped into this cell or as a function of the number of nodes grouped into this cell.

4. Method according to claim 1, wherein use is made of the second node of the pair identified as starting node or another as yet ungrouped node to perform a fragmentation of data following this second node by repeating the operations performed during the first fragmentation.

5. Method according to claim 1 wherein the parameter is determined in a manner inversely proportional to the quantity of data associated with one of the nodes of the identified pair.

6. Method according to claim 1, wherein the parameter is determined in proportion to the ratio between the number of nodes grouped into the temporary cell prior to the first node of the identified pair of nodes and the number of nodes in the temporary cell.

7. Method according to claim 1, wherein the multimedia data comprise data relating to at least one of the following documents: an audio document, a video document, a program, a text document.

8. Method according to claim 6, wherein the video data correspond to at least one of the following elements: an image, a sequence of images, this or these images being two- or three-dimensional, a panorama, graphical data.

9. Method according to claim 8, wherein the images relating to viewpoints of scenes or of objects, neighbouring nodes correspond to viewpoints close to these scenes or to these objects.

10. Method of fragmenting multimedia data, wherein navigation nodes are associated with these data as a function of their nature and/or their function, a compression of these data is performed by eliminating the redundant data, the data retained being associated with the node relating to the data eliminated, and these data are fragmented according to a method of fragmentation in accordance with one of the preceding claims.

11. Method according to claim 9, wherein the data considered comprising video data relating to real images and to synthetic images, the navigation nodes are associated with the multimedia data by imposing access to the data relating to real images.

12. Computer program product comprising program code instructions for executing the steps of the method of fragmenting multimedia data according to claim 1, when the program is executed on a computer.

13. Device for fragmenting multimedia data associated with navigation nodes comprising:
means for accessing a data item by means of a node associated with this data item,
means for determining access to a second node, the so-called next node, from a first node, the so-called previous node,
wherein it comprises:
means for grouping, commencing with a predetermined starting node, into a temporary cell, data whose associated nodes follow one another until this cell reaches a threshold size,
means for identifying a pair of next nodes minimizing a parameter proportional to the number of data common to the data associated with the two nodes of the pair and
means for forming a cell with the data associated with the first node of the pair and with the nodes previous to the latter node,
the said device preferably being adapted to implement a method according to claim 1.
